(19) United States
(12) Patent Application Publication
(10) Pub. No.: US 2005/0252548 A1
(43) Pub. Date: Nov. 17, 2005

(54) Metal hydride hydrogen storage and delivery system

(76) Inventors: Ned Stetson, Lake Orion, MI (US); Charles Stahl, Algonac, MI (US); Daniel Bovinich, Rochester Hills, MI (US)

Correspondence Address: ENERGY CONVERSION DEVICES, INC., 2956 WATERVIEW DRIVE, ROCHESTER HILLS, MI, 48309, US

(21) Appl. No.: 10/887,432

(22) Filed: Jul. 8, 2004

Related U.S. Application Data
(60) Provisional application No. 60/570,714, filed on May 13, 2004.

(51) Int. Cl. G05D 16/00

(52) U.S. Cl. 137/72

(57) ABSTRACT

A hydrogen storage and delivery system utilizing a hydrogen storage material to store hydrogen in hydride form. The hydrogen storage and delivery system utilizes a venting mechanism including a thermal fuse designed to melt away at a given temperature thereby venting the stored hydrogen to the atmosphere.

### CROSS REFERENCE TO RELATED APPLICATIONS

The present application is entitled to the benefit of the earlier filing date and priority of, co-pending U.S. Patent Application Ser. No. 60/570,714, which is assigned to the same assignee as the current application, entitled “METAL HYDRIDE HYDROGEN STORAGE AND DELIVERY SYSTEM,” filed May 13, 2004, the disclosure of which is hereby incorporated by reference.

### FIELD OF THE INVENTION

The present invention generally relates to safe storage and delivery of gaseous hydrogen from a metal hydride hydrogen storage container.

### BACKGROUND

With the recent developments in fuel cells and hydrogen powered internal combustion engines, hydrogen is becoming increasingly more viable as an everyday fuel. For hydrogen to be accepted as an everyday fuel, hydrogen storage and refueling systems must be designed with efficiency and safety in mind. While hydrogen has wide potential application as a fuel, a major drawback is in its storage. Traditionally, hydrogen has been stored in pressure containment vessels under a high pressure or stored as a cryogenic liquid cooled to an extremely low temperature. Storage of hydrogen as a compressed gas or liquid generally involves the use of large and bulky pressure containment vessels. Storage of hydrogen in these forms results in a limited amount of stored hydrogen with respect to the overall volume or weight of the system.

Certain metals and alloys have been demonstrated to reversibly store and release of hydrogen at improved storage density. In this regard, these metals and alloys have been considered as a superior hydrogen-storage material, due to their high hydrogen-storage efficiency. Solid phase metal or alloy systems store hydrogen by forming a metal hydride under specific temperature/pressure conditions. Hydrogen is then released from the metal hydride by changing these conditions. Examples of hydrogen storage alloys utilized for thermal hydrogen storage can be found in U.S. Pat. Nos. 4,431,561, 6,517,970 and 6,616,891.

U.S. Pat. No. 4,431,561 to Ovshinsky et al. entitled “Hydrogen Storage Materials And Method Of Making Same” discloses a hydrogen storage material for reversibly storing hydrogen formed from a lightweight matrix which is chemically and structurally modified to improve its hydrogen storage properties. The modified hydrogen storage alloy possesses a greatly increased density of catalytically active sites which improves hydrogen storage kinetics and increases resistance to poisoning.

U.S. Pat. No. 6,517,970 to Ovshinsky et al. entitled “Non-pyrophoric Hydrogen Storage Alloy” discloses low temperature hydrogen storage alloys that have been modified to be non-pyrophoric upon exposure to ambient atmosphere. These alloys have a hydrogen storage capacity of at least 1.5 weight percent and can obtain at least 80% of its total hydrogen storage capacity within 1 minute.

U.S. Pat. No. 6,616,891 to Sapru et al. entitled “High Capacity Transition Metal Based Hydrogen Storage Materials For The Reversible Storage Of Hydrogen” discloses reversible hydrogen storage alloys capable of absorbing approximately 4 weight percent hydrogen and desorbing up to 2.8 weight percent hydrogen at temperatures up to 150° C.

While many of the problems associated with storing hydrogen in metal hydride form have been addressed before, precautions must still be taken to prevent the pressure containment vessels from failing upon exposure to high temperatures. Many pressure containment vessels utilize pressure relief valves to vent stored gas upon the occurrence of a pressure build-up inside the vessel and/or exposure of the vessel to high temperatures. However, current designs do not successfully prevent uncontrolled rupturing of metal hydride hydrogen storage vessels upon exposure to extreme conditions.

### SUMMARY OF THE INVENTION

Disclosed herein, is a metal hydride hydrogen storage and delivery system comprising a pressure containment vessel at least partially filled with a hydrogen storage material, a valve assembly connected to the pressure containment vessel having a valve head block including a delivery channel and a venting channel. A delivery valve core in a normally closed position may be disposed in the delivery channel and a venting mechanism in a normally closed position may be disposed in the venting channel. Preferably, the venting channel and the delivery channel and/or the delivery valve core and the venting mechanism are set off from one another such that the delivery valve core and the venting channel do not interfere with one another when the venting mechanism is actuated.

A mating connector may be releasably coupled to the valve assembly in mechanical communication with the delivery valve core. The mating connector or the valve assembly may include an electrical actuator and an actuating member in mechanical communication with the electrical actuator. The electrical actuator may comprise a solenoid. The solenoid preferably requires a spike voltage of 19±1 V to actuate the delivery valve core and an operating or steady state voltage of 6±1 V to maintain the delivery valve core in the open position. Upon an application of force on the actuating member by the electrical actuator, the actuating member actuates the delivery valve core into an open position. The actuating member preferably has a travel of at least 0.03 inches. The actuating member may be any device capable of having a travel of at least 0.03 inches such as a plunger, a piston, a rod, a plate, etc.

The venting mechanism may be a safety relief device that provides gaseous communication between the pressure containment vessel and the atmosphere upon activation when the hydrogen storage and delivery system exceeds a threshold temperature and/or a threshold pressure. The threshold temperature is preferably in the range of 120 to 175° C. (250 to 350° F.) for aluminum vessels. The threshold temperature may be higher for steel vessels and may be lower for composite vessels. The threshold pressure is preferably in the range of 7240 to 8270 kPa (1050 to 1200 psia). The venting mechanism preferably includes a thermal fuse. A thermal fuse is a device having at least a portion comprised of a metal/alloy having a melting point at a threshold temperature such that at least a portion of the thermal fuse melts away allowing the stored hydrogen to vent from the hydrogen storage and delivery system through the venting channel when the temperature of the hydrogen storage and delivery system is above or equal to the threshold temperature. The thermal fuse may be comprised of a eutectic alloy.

### BRIEF DESCRIPTION OF THE DRAWINGS

FIG. 1, is a depiction of the hydrogen storage and delivery system in accordance with a preferred embodiment of the present invention.

FIG. 2, is an exploded view of the hydrogen storage and delivery system in accordance with a preferred embodiment of the present invention.

FIG. 3, is a close up view of the valve assembly shown in accordance with a preferred embodiment of the present invention.

### DETAILED DESCRIPTION OF THE PREFERRED EMBODIMENTS OF THE INVENTION

Disclosed herein, is a hydrogen storage and delivery system including a hydrogen storage material to store hydrogen in hydride form, a pressure containment vessel at least partially filled with a hydrogen storage material, and a valve assembly for sealing the pressure containment vessel. In one embodiment, the valve assembly is designed to vent any stored hydrogen upon exposure to high temperatures and/or a pressure build-up within the pressure containment vessel.

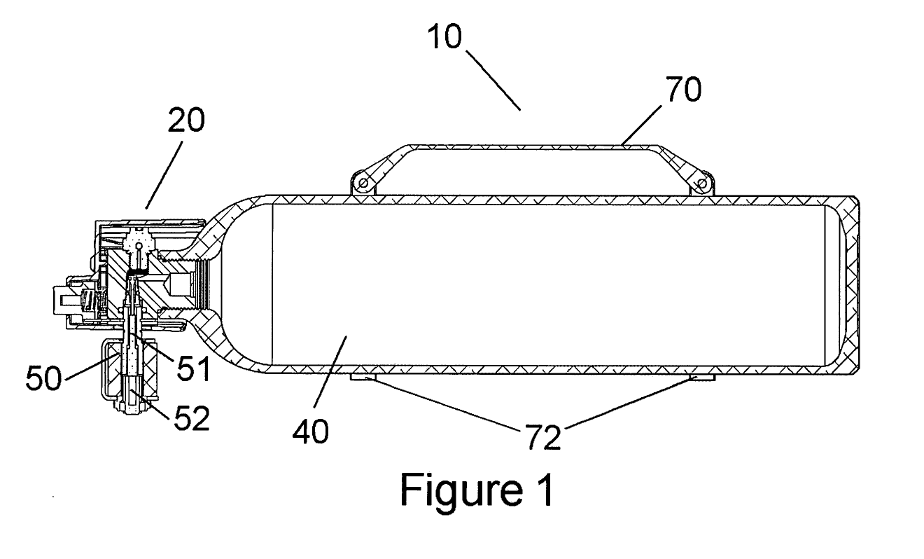

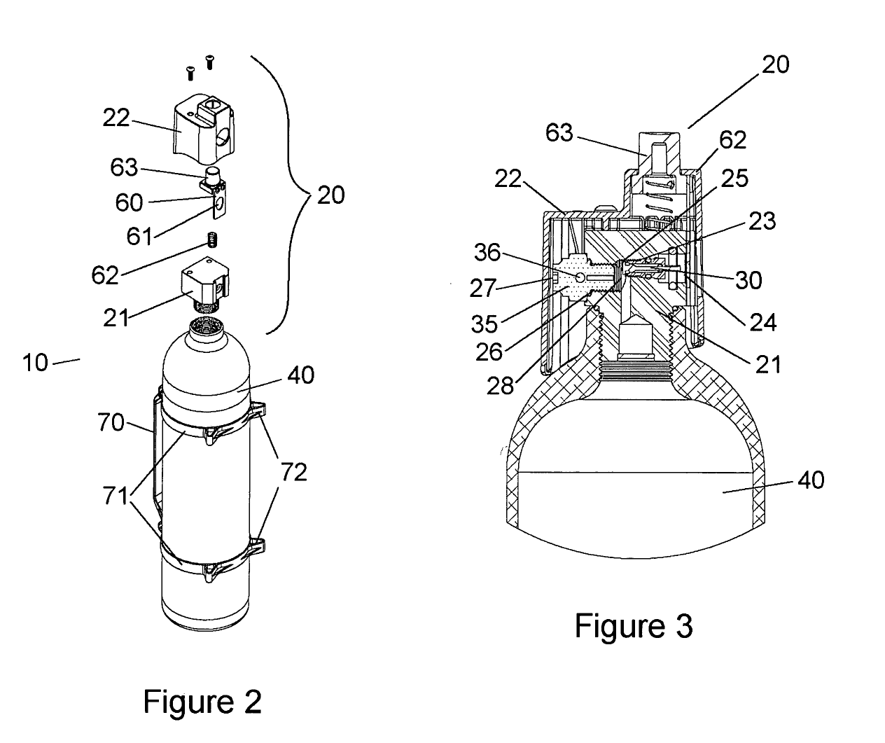

A preferred embodiment of the hydrogen storage and delivery system having a valve assembly designed to vent hydrogen is depicted in FIG. 1 and FIG. 2. The hydrogen storage and delivery system 10 includes a valve assembly 20 and a pressure containment vessel 40 at least partially filled with a hydrogen storage material. The valve assembly 20 may be detachably connected to the pressure containment vessel 40. The valve assembly 20 includes a valve head block 21 disposed inside a valve housing 22. The valve head block 21 includes a delivery channel 23 having an exterior delivery port 24 and an interior delivery port 25. The delivery channel 23 provides a path for hydrogen to be supplied to or from the pressure containment vessel 40. The valve head block 21 may also include a venting channel 26 having an exterior venting port 27 and an interior venting port 28. The venting channel 26 permits the venting of hydrogen gas upon exposure to high temperatures and/or a pressure build-up within the system. Preferably, the interior delivery port 25 is offset (i.e. not inline with the interior venting port) from the interior venting port 28. Preferably, the interior delivery port is offset from the interior venting port such that actuated delivery valve core does not hinder the flow of hydrogen exiting the pressure containment vessel.

A delivery valve core 30 may be disposed in the delivery channel 23 of the valve head block 21. The delivery valve core may be any valve mechanism designed to permit or ceases the flow of a fluid through a channel. The delivery valve core 30 includes an open/close mechanism that is preferably biased in a normally closed position. A depiction of a valve assembly having a delivery valve core is shown in FIG. 3. When actuated, the open/close mechanism moves to the open position which provides a pathway for hydrogen to enter or exit the hydrogen storage and delivery system 10. The open/close mechanism may include a piston and a biasing member supported in the delivery valve core 30, whereby the biasing member forces the piston into a closed position to prevent hydrogen from flowing into or out of the valve assembly 20. When the pressure inside the system is greater than atmospheric pressure, the internal pressure also acts to maintain the piston in a closed position. An example of a suitably delivery valve core is a “Schrader valve”, manufactured by Schrader-Bridgeport, Inc.

The exterior delivery port 24 of the valve assembly 20 may be adapted to receive a mating connector 50. A mating connector is any adapter suitable for providing gaseous communication between the pressure containment vessel and a hydrogen supply, such as a refueling tank, or a hydrogen consuming application, such as a fuel cell system, internal combustion system, etc. The mating connector may be part of a manifold assembly for distributing the hydrogen supplied from one or more of the hydrogen storage and delivery systems to a hydrogen consuming application.

The mating connector 50 preferably includes an actuating member 51 supported by the mating connector in mechanical communication with an electrical actuator 52. The actuating member 51 may be any suitably device for actuating the open/close mechanism of the delivery valve core of the valve assembly. The electrical actuator 52 may be any suitable device for moving or translating the actuating member 51. During operation the mating connector 50 is attached to the valve assembly 20. When power is supplied to the electrical actuator 52, the electrical actuator may apply a force on the actuating member 51 such that the actuating member opens the delivery valve core 30 of the valve assembly 20 to provide gaseous communication between the pressure containment vessel and the hydrogen consuming or supplying application through the mating connector 50. When the power supply to the electrical actuator is terminated or reduced below a value, the delivery valve core is closed.

The actuating member 51 is preferably adapted to provide enough force to the open/close mechanism of the delivery valve core to overcome the force maintaining the delivery valve core in the closed position. Preferably the electrical actuator provides the actuating member with enough travel to sufficiently open the delivery channel to accommodate any manufacturing tolerances of the, delivery valve core. When charged with hydrogen, the pressure containment vessel may have an internal pressure in the range of 170 to 2860 kPa (25 to 415 psia), and under certain conditions may reach as high as 7580 kPa (1100 psia). Therefore the force provided by the actuating member on the open close mechanism of the delivery valve core must be at least high enough to overcome the force exerted on the open/close mechanism by the internal pressure of the pressure containment vessel and the force of the open/close mechanism of the delivery valve core. Preferably, the force provided by the actuating member on the open/close mechanism is high enough to overcome the force exerted on the open/close mechanism by the internal pressure of the pressure containment vessel where the internal pressure exceeds the normal operating pressure by at least 100%. Most preferably, the force provided by the actuating member on the open/close mechanism is high enough to overcome the force exerted on the open/close mechanism by the internal pressure of the pressure containment vessel where the internal pressure exceeds the normal operating pressure by at least 150%. The actuating member has a travel of approximately 0.03 inches, however, due to the complexity of the valve assembly, the actuating member preferably has a travel greater than 0.03 inches. When the mating connector is coupled to the valve assembly, the actuating member and the open/close mechanism in the delivery valve core may be separated by a gap to prevent the delivery valve core from being unintentionally actuated upon the mating connector being coupled to the valve assembly. Due to manufacturing tolerances, the gap may be in the range of 0.000 to 0.025 inches, however, the open/close mechanism of the delivery valve core and the actuating member are preferably separated by a target gap in the range of 0.005 to 0.015 inches.

The electrical actuator preferably operates with a spike voltage of 19V±1V. For example, the electrical actuator may include a solenoid designed to operate at a voltage of 19V±1V. The solenoid may require an initial spike voltage of approximately 19V to apply a force on the actuating member such that the actuating member sufficiently actuates the delivery valve core. The solenoid may also require a continuous voltage of approximately 6V±1V thereafter to apply a force on the actuating member to maintain the delivery valve core in the open position.

Referring now to FIGS. 1-3, as shown, a venting mechanism 35 in gaseous communication with the pressure containment vessel 40 is disposed in the venting channel 26 of the valve head block 21. The venting mechanism 35 vents stored hydrogen from the pressure containment vessel 40 upon a build-up in pressure inside the pressure containment vessel and/or upon exposure to high temperatures. The venting channel 26 provides a passageway for hydrogen gas to exit the pressure containment vessel 40.

The venting channel 26 may include a thermal fuse. A thermal fuse 36 is a device that allows stored gas to vent from the pressure containment vessel upon reaching a threshold temperature. The thermal fuse 36 has a melting point such that at least a portion of the thermal fuse will melt away upon exposure to a given temperature thereby allowing any stored hydrogen to vent from the system through the venting port. The pressure containment vessels containing metal hydride material utilized for the storage of hydrogen preferably have a threshold temperature in the range of 120-175° C. (250-350° F.). The thermal fuse preferably has a melting temperature in that range. Preferably the thermal fuse has a melting temperature of in the range of 110 to 130° C. (230 to 270° F.). The thermal fuse is preferably formed from a eutectic alloy allowing the fuse to melt away at the lowest possible temperature given the alloy components. A pressure relief device may also be included in the venting mechanism. The pressure relief device may be a reclosable pressure relief valve including a plunger and a translating member holding the plunger in the closed position. Upon a build-up of pressure in the system, the plunger is forced into an open position, thereby allowing the stored hydrogen to vent from the system through the venting port. Preferably, the pressure relief device is set in the range of 7240 to 8270 kPa (1050-1200 psia). Preferably, the pressure relief device is forced into an open position upon the system reaching an internal pressure of approximately 7580 kPa (1100 psia).

The delivery valve core 30 and the venting mechanism 35 are preferably offset with respect to each other inside the valve assembly 20. Preferably, the delivery mechanism 30 and the venting mechanism 35 are offset such that the delivery channel 23 and the venting channel 26 are not in line with one another. The offset should be such that the piston in the delivery valve core, when in the open position or in a failed position, does not restrict flow of hydrogen through the venting channel. Offsetting the delivery valve core and the venting mechanism improves the safety of the hydrogen storage and delivery system in extreme conditions.

The valve assembly 20 may further include a guard disposed adjacent to the delivery port 24. The guard is preferably a movable plate 60. As shown, the movable plate 60 includes an opening 61 through which a mating connector may be coupled to the delivery mechanism 30 when the movable plate 60 is in the open position. The movable plate is normally maintained in a closed position blocking access to the delivery valve core. The valve assembly 20 may also include a translating member 62 for biasing the plate in the normally closed position to cover the delivery port 24. The translating member 62 may be a spring or another device designed to apply a force on the movable plate. The movable plate 60 may ride in a set of channels formed in the valve head block or the valve housing. The movable plate may be a solid piece having a hole for engaging a mating connector. When in the closed position, the movable plate shields the delivery port from outside contact, thereby preventing the delivery valve core from being engaged accidentally. The valve assembly may also include a button for actuating the movable plate 60. The movable plate may be actuated by applying a force onto the button. Upon application of a force on the button 63, the movable plate 60 moves to an open position exposing the delivery valve core 30 disposed in the delivery channel 23. When the movable plate 60 is in the open position a mating connector 50 may be inserted through the hole 61 in the movable plate 60 and be coupled to the delivery valve core 30. Upon the mating connector 50 being coupled to the delivery valve core, the force applied on the button 63 is removed allowing the translating member 62 to apply a force on the movable plate 60 to engage the mating connector thereby locking the mating connector into the coupled position with the valve assembly 20 in mechanical communication with the delivery valve core 30. The mating connector 50 may have a groove which accepts a portion of the movable plate, such as an edge, around the hole 61 of the movable plate 60 such that the mating connector is further secured into place. To remove the mating connector, a force may be applied on the button to unlock the mating connector, and the mating connector may be removed.

The pressure containment vessel 40 may be any vessel capable of holding metal hydride hydrogen storage material under pressure. The pressure containment vessel is preferably adapted for use in the horizontal position. The pressure containment vessel is preferably a cylindrical vessel with a longitudinal axis having an opening on one end. The vessel may include a restricted neck. The opening may be formed in the restricted neck, which may be threaded for the attachment of the pressure containment vessel to the valve assembly. The pressure containment vessel may be formed from aluminum, stainless steel, polymers, composites or other materials suitable for constructing such vessels provided the materials are not reactive with the materials stored therein. Preferably, the pressure containment vessel is formed from a conductive material allowing for heat transfer between the contents of the pressure containment vessel and the atmosphere. The pressure containment vessel may have an operating pressure in the range of 170 to 2860 kPa (25 to 415 psia) when the hydrogen storage material disposed therein is charged with hydrogen.

The hydrogen storage material utilized in the pressure containment vessel may include one or more hydrogen storage alloys. The hydrogen storage alloys may be selected from one or more Rare-earth metal alloys, Misch metal based alloys, zirconium based alloys, titanium based alloys, magnesium based alloys, and magnesium/nickel based alloys, which may be AB, AB₂ or AB₅ type alloys. The hydrogen storage alloys may also include one or more modifier elements which improve the hydrogen storage characteristics thereof.

Heat transfer means, such as fins or heat exchanger tubing may be disposed inside the pressure containment vessel to promote uniform distribution of heat throughout the vessel interior during hydrogen desorption and to aid in the removal of heat from the vessel during hydrogen absorption. Heat transfer fins may also be used to compartmentalize the interior of the pressure containment vessel to provide for uniform distribution of the hydrogen storage material utilized therein. Examples of heat transfer fins are described in detail in U.S. Pat. Nos. 6,626,323 and 6,709,497, the disclosures of which are hereby incorporated by reference.

The pressure containment vessel 40 may also include a handle 70 attached thereto. The handle 70 is preferably attached to the side of the vessel and preferably extends at least a quarter of the length of the vessel and more preferably extends at least half of the length of the vessel. When attached to the side of the vessel, the handle is preferably disposed parallel to the axis of the vessel. The handle may be attached to the vessel by one or more straps 71 wrapping around the vessel. On the side of the vessel opposite the handle, the one or more straps used to attach the handle to the vessel may have one or more stabilizing members 72 protruding from the strap away from the vessel acting to stabilize the pressure containment vessel when disposed in a horizontal position. The stabilizing members may prevent the hydrogen storage and delivery system from rolling when disposed on its side, or in the horizontal position. Alternatively, the one or more stabilizing members may be integral with and extend away from the pressure containment vessel.

While there has been described herein above what are believed to be the preferred embodiments of the claimed invention as defined below, those skilled in the art will recognize that other and further changes and modifications may be made thereto without departing from the spirit and scope of the invention, and it is intended to claim all such changes and modifications as fall within the claims and their equivalents thereof.

1. A metal hydride hydrogen storage and delivery system comprising:
a pressure containment vessel at least partially filled with a hydrogen storage material;
a valve assembly connected to said pressure containment vessel having a valve head block, said valve head block including a delivery channel with a delivery valve core biased in a normally closed position disposed therein and a venting channel with a venting mechanism in a normally closed position disposed therein; and
a mating connector releasably coupled to said valve assembly in mechanical communication with said delivery valve core, said mating connector including an actuating member supported by said mating connector for actuating said delivery valve core into an open position, said actuating member having a travel of at least 0.03 inches and providing a force to overcome the counterforce against said delivery valve core from the internal pressure of said pressure containment vessel where the internal pressure exceeds the normal operating pressure.

2. The metal hydride hydrogen storage and delivery system according to claim 1, wherein said actuating member and said delivery valve core are separated by a target gap of 0.05 to 0.015 inches.

3. The metal hydride hydrogen storage and delivery system according to claim 1, wherein said normal operating pressure is in the range of 25 to 415 psia.

4. The metal hydride hydrogen storage and delivery system according to claim 1, wherein said actuating member provides a force to overcome the counterforce against said delivery valve core from the internal pressure of said pressure containment vessel where the internal pressure exceeds the normal operating pressure operating pressure by at least 100%.

5. The metal hydride hydrogen storage and delivery system according to claim 4, wherein said actuating member provides a force to overcome the counterforce against said delivery valve core from the internal pressure of said pressure containment vessel where the internal pressure exceeds the normal operating pressure operating pressure by at least 150%.

6. The metal hydride hydrogen storage and delivery system according to claim 1, wherein said electrical actuator comprises a solenoid.

7. The metal hydride hydrogen storage and delivery system according to claim 6, wherein said solenoid requires a voltage of 19±1 V to actuate said delivery valve core.

8. The metal hydride hydrogen storage and delivery system according to claim 6, wherein said solenoid requires a voltage of 6±1 V to maintain said delivery valve core in the open position.

9. The metal hydride hydrogen storage and delivery system according to claim 1, wherein said actuating member has a travel greater than 0.30 inches.

10. The hydrogen storage and delivery system according to claim 1, wherein said venting mechanism provides gaseous communication between the pressure containment vessel and the atmosphere upon said hydrogen storage and delivery system exceeding a threshold temperature and/or the interior of said hydrogen storage and delivery system exceeding a threshold pressure.

11. The metal hydride hydrogen storage and delivery system according to claim 10, wherein said threshold temperature is in the range of 250 to 325° F.

12. The metal hydride hydrogen storage and delivery system according to claim 10, wherein said threshold pressure is in the range of 1050 to 1200 psia.

13. The metal hydride hydrogen storage and delivery system according to claim 10, wherein said venting mechanism further includes a thermal fuse, said thermal fuse having a melting point at said threshold temperature such that said thermal fuse melts away allowing the stored hydrogen to vent from said system through said venting channel when the temperature of the system is above or equal to said threshold temperature.

14. The metal hydride hydrogen storage and delivery system according to claim 1 further comprising a movable plate disposed adjacent to said delivery channel on the exterior of said valve head block, said movable plate covering said delivery valve core when in a closed position, said movable plate having an opening through which a mating connector is coupled to said valve assembly accessing said delivery valve core when said movable plate is in an open position.

15. The metal hydride hydrogen storage and delivery system according to claim 1, wherein said venting channel and said delivery channel are offset from one another

16. The metal hydride hydrogen storage and delivery system according to claim 1, wherein said delivery valve core and said venting mechanism are offset from one another.

17. A metal hydride hydrogen storage and delivery system comprising:
a pressure containment vessel at least partially filled with a hydrogen storage material;
a valve assembly connected to said pressure containment vessel having a valve head block, said valve head block including a delivery channel with a delivery valve core biased in a normally closed position disposed therein; and
a mating connector releasably coupled to said valve assembly in mechanical communication with said delivery valve core, said mating connector including an electrical actuator and an actuating member in mechanical communication with said electrical actuator for actuating said delivery valve core into an open position, said actuating member having a travel of at least 0.03 inches and providing a force to overcome the counterforce against said delivery valve core from the internal pressure of said pressure containment vessel where the internal pressure exceeds the normal operating pressure.

18. The metal hydride hydrogen storage and delivery system according to claim 17, wherein said normal operating pressure is in the range of 25 to 415 psia.

19. The metal hydride hydrogen storage and delivery system according to claim 17, wherein said actuating member provides a force to overcome the counterforce against said delivery valve core from the internal pressure of said pressure containment vessel where the internal pressure exceeds the normal-operating pressure operating pressure by at least 100%.

20. The metal hydride hydrogen storage and delivery system according to claim 19, wherein said actuating member provides a force to overcome the counterforce against said delivery valve core from the internal pressure of said pressure containment vessel where the internal pressure exceeds the normal operating pressure operating pressure by at least 150%.

21. The metal hydride hydrogen storage and delivery system according to claim 17, wherein said electrical actuator comprises a solenoid.

22. The metal hydride hydrogen storage and delivery system according to claim 21, wherein said solenoid requires a voltage of 19±1 V to actuate said delivery valve core.

23. The metal hydride hydrogen storage and delivery system according to claim 21, wherein said solenoid requires a voltage of 6±1 V to maintain said delivery valve core in the open position.

24. The metal hydride hydrogen storage and delivery system according to claim 17, wherein said actuating member has a travel greater than 0.30 inches.

25. The metal hydride hydrogen storage and delivery system according to claim 17, wherein said actuating member is a plunger or a piston.

26. A metal hydride hydrogen storage and delivery system comprising:
a pressure containment vessel at least partially filled with a hydrogen storage material; and
a valve assembly connected to said pressure containment vessel having a valve head block, said valve head block including a delivery channel and a venting channel, said venting channel and said delivery channel being offset from one another.

27. The hydrogen storage and delivery system according to claim 26, wherein said valve assembly further includes a delivery valve disposed in said delivery channel and a normally closed venting mechanism disposed in said venting channel.

28. The hydrogen storage and delivery system according to claim 27, wherein said venting mechanism provides gaseous communication between the pressure containment vessel and the atmosphere upon said system exceeding a threshold temperature and/or the interior of said system exceeding a threshold pressure.

29. The metal hydride hydrogen storage and delivery system according to claim 28, wherein said threshold temperature is in the range of 250 to 325° F.

30. The metal hydride hydrogen storage and delivery system according to claim 28, wherein said threshold pressure is in the range of 1050 to 1150 psia.

31. The metal hydride hydrogen storage and delivery system according to claim 28, wherein said venting mechanism further includes a thermal fuse, said thermal fuse having a melting point at said threshold temperature such that said thermal fuse melts away allowing the stored hydrogen to vent from said system through said venting channel when the temperature of the system is above or equal to said threshold temperature.

32. The metal hydride hydrogen storage and delivery system according to claim 31, wherein said thermal fuse is comprised of a eutectic alloy.

33. The metal hydride hydrogen storage and delivery system according to claim 26 further comprising a movable plate disposed adjacent to said delivery port, said movable plate covering said delivery mechanism when in a closed position, said movable plate having an opening through which a mating connector is coupled to said delivery mechanism when said movable plate is in an open position.

34. The metal hydride hydrogen storage and delivery system according to claim 33, wherein said movable plate is normally maintained in a closed position by a translating member biasing the plate in an upward direction.
